(19) United States
(12) Patent Application Publication
(10) Pub. No.: US 2016/0183057 A1
(43) Pub. Date: Jun. 23, 2016

(54) METHOD AND SYSTEM FOR HYBRID LOCATION DETECTION

(71) Applicant: INTEL CORPORATION, Santa Clara, CA (US)

(72) Inventor: Itai Steiner, Tel Aviv (IL)

(73) Assignee: INTEL CORPORATION, Santa Clara, CA (US)

(21) Appl. No.: 14/575,135

(22) Filed: Dec. 18, 2014

(51) Int. Cl. H04W 4/02; G01S 5/02

(52) U.S. Cl. CPC H04W 4/027; G01S 5/0263

(57) ABSTRACT

The disclosure generally relates to a method and apparatus for hybrid location detection. The disclosed embodiments enable location determination for a mobile device in communication with one or more Access Points (APs) and an optical camera capable of measuring distance to a known object. In an exemplary embodiment, the camera is used to determine distance form a known object or a known location (i.e., anchor). In addition, using Wi-Fi infrastructure, round-trip signal propagation time may be used to determine one or more ranges from known access points (APs) connected. Round-trip signal propagation time may be measured, for example, by using a Time-Of-Flight algorithm. Additionally, trilateration algorithms may be used to determine a course location for the mobile device relative to the APs. Using a combination of optical distance measurement and the course location, the exact location of the mobile device may be determined.

### BACKGROUND

1. Field

The disclosure relates to a method, apparatus and system to fuse multiple detection systems to accurately determine location of a mobile device.

2. Description of Related Art

Outdoor navigation is widely deployed due to advancement in various global positioning systems (GPS). Recently, there has been an increased focus on indoor navigation and position location. Indoor navigation differs from outdoor navigation because the indoor environment precludes receiving GPS satellite signals. As a result, effort is now directed to solving the indoor navigation problem. As yet, this problem does not have a scalable solution with satisfactory precision.

A solution to this problem may be based on the Time-of-Flight (ToF) method. ToF is defined as the overall time a signal propagates from the user to an access point (AP) and back to the user. This value can be converted into distance by dividing the signal's roundtrip travel time by two and multiplying it by the speed of light. This method is robust and scalable but requires significant hardware changes to the Wi-Fi modem and other devices. The ToF range calculation depends on determining the precise signal receive/transmit times. As little as 3 nanoseconds of discrepancy will result in about 1 meter of range error.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 shows information flow for a conventional location determination system;

FIG. 2 is an exemplary representation of an embodiment of the disclosure;

FIG. 3 schematically represents a location determination environment according to certain embodiments of the disclosure;

FIG. 4 schematically represents accurate location determination where conflicting anchors are present;

FIG. 5 is an exemplary apparatus for implementing an embodiment of the disclosure;

and

FIG. 6 shows exemplary computer instructions stored at a computer-readable storage device according to one implementation of the disclosure.

### DETAILED DESCRIPTION

Certain embodiments may be used in conjunction with various devices and systems, for example, a mobile phone, a smartphone, a laptop computer, a sensor device, a Bluetooth (BT) device, an Ultrabook™, a notebook computer, a tablet computer, a handheld device, a Personal Digital Assistant (PDA) device, a handheld PDA device, an on board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AV) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Institute of Electrical and Electronics Engineers (IEEE) standards (IEEE 802.11-2012, IEEE Standard for Information technology-Telecommunications and information exchange between systems Local and metropolitan area networks—Specific requirements Part 11: Wireless LAN Medium Access Control (MAC) and Physical Layer (PHY) Specifications, Mar. 29, 2012; IEEE 802.11 task group ac (TGac) (“IEEE 802.11-09/0308r12—TGac Channel Model Addendum Document”); IEEE 802.11 task group ad (TGad) (IEEE 802.11ad-2012, IEEE Standard for Information Technology and brought to market under the WiGig brand—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 Dec. 2012)) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing Wireless HDTM specifications and/or future versions and/or derivatives thereof, units and/or devices which are part of the above networks, and the like.

Some embodiments may be implemented in conjunction with the BT and/or Bluetooth low energy (BLE) standard. As briefly discussed, BT and BLE are wireless technology standard for exchanging data over short distances using short-wavelength UHF radio waves in the industrial, scientific and medical (ISM) radio bands (i.e., bands from 2400-2483.5 MHz). BT connects fixed and mobile devices by building personal area networks (PANs). Bluetooth uses frequency-hopping spread spectrum. The transmitted data are divided into packets and each packet is transmitted on one of the 79 designated BT channels. Each channel has a bandwidth of 1 MHz. A recently developed BT implementation, Bluetooth 4.0, uses 2 MHz spacing which allows for 40 channels.

Some embodiments may be used in conjunction with one way and/or two-way radio communication systems, a BT device, a BLE device, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like. Some demonstrative embodiments may be used in conjunction with a WLAN. Other embodiments may be used in conjunction with any other suitable wireless communication network, for example, a wireless area network, a “piconet”, a WPAN, a WVAN and the like.

Outdoor navigation has been widely deployed due to the development of various systems including: global-navigation-satellite-systems (GNSS), Global Positioning System (GPS), Global Navigation Satellite System (GLONASS) and GALILEO. Indoor navigation has been receiving considerable attention.

In one embodiment of the disclosure, a hybrid technique including the ToF method is used to address indoor navigation. As discussed above, ToF is defined as the overall time a signal propagates from the user to an access point (“AP”) and back to the user. This ToF value can be converted into distance by dividing the time by two and multiplying it by the speed of light. The ToF method is robust and scalable but requires hardware changes to the existing Wi-Fi modems. ToF systems also suffer from limited accuracy in that the calculated position may be in error as much as 3 meters. ToF measurements also require exact knowledge of the location of the AP's in communication with the mobile device. Finally, multipath, non-line of sight and obstacles interference impact and degrade the quality and accuracy of ToF measurements.

New smart devices (e.g., smartphones, smart glasses, body mounted cameras and self-guided robots) are emerging with optical and Wi-Fi connectivity capabilities. Such devices include visual-based ranging system capable of determining an optical distance form an object. Visual-based ranging systems provide high accuracy but have a limited point-of-view (“POV”) and lack of angular coverage. The accuracy of such devise is about a few centimeters. Therefore, such devices provide very limited geometric dilution of precision (“GDOP”). GDOP has been used to specify the additional multiplicative effect of navigation satellite geometry on positional measurement precision. In its simplest form, GDOP is a calculation of an error measurement due to positional geometry of the camera (or the satellite) relative to the object under measurement. Further, the viewing angle of the visual-based ranging systems are limited to the specific sector in the angular coverage of the view finder. Finally, power consumption of such devices is significantly higher if they are operating continually and are conducting in-depth camera distance determination.

These and other deficiencies of indoor and outdoor navigation systems are addressed according to the disclosed embodiments. In one embodiment of the disclosure, information from different sources are fused to increase position accuracy while conserving device power. An exemplary location engine according to one embodiment of the disclosure receives optical range measurement from an optical device to a specified, known object (i.e., anchor object). The anchor object may be in the field of view (FOV) of the user device. The location engine may also receive ToF measurements for additional spatial information and to enhance GDOP and to provide a better device location estimation.

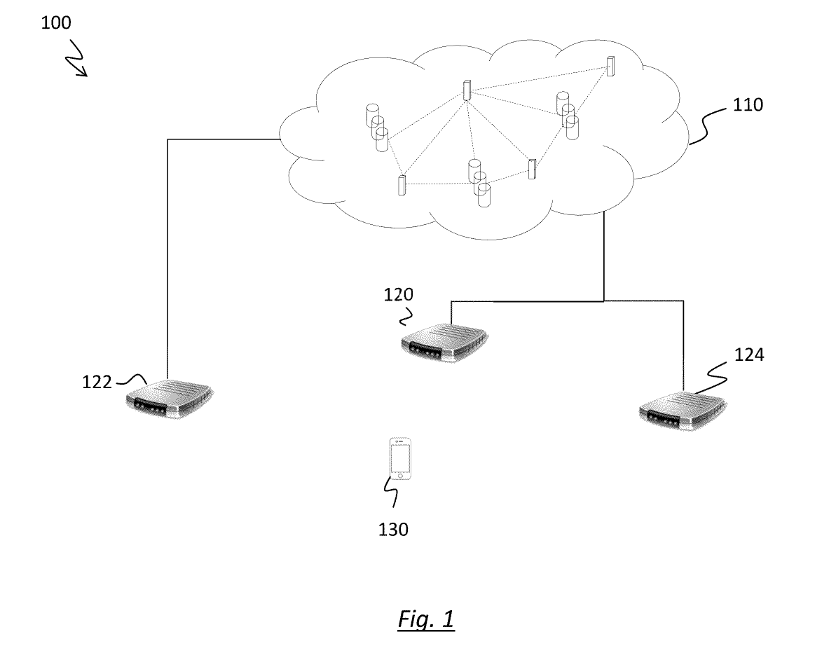

FIG. 1 is an exemplary wireless environment. Environment 100 of FIG. 1 may include a wireless communication network, including one or more wireless communication devices capable of communicating content, data, information and/or signals over a wireless communication medium (not shown). The communication medium may include a radio channel, an infrared (IR) channel, a Wi-Fi channel or the like. One or more elements of environment 100 may optionally be configured to communicate over any suitable wired communication link. Environment 100 may be an indoor environment, an enclosed area or a part of a multi-level structure.

Network 110 of FIG. 1 enables communication between environment 100 and other communication environments. Network 110 may further include servers, databases and switches. Network 110 may also define a cloud communication system for communicating with APs 120, 122 and 124. While environment 100 may have many other APs, for simplicity, only APs 120, 122 and 124 are illustrated in FIG. 1. Communication between the APs and network 110 may be through a wireless medium or a through direct connection. Further, the APs may communicate with each other wirelessly or through landline. Each AP may be directly linked to cloud 110, or it may communicate with cloud 110 thought another AP (a relay switch). Each AP may define a router, a relay station, a base station or any other device configured to provide radio signal to other devices.

Communication device 130 communicates with APs 120, 122 and 124. Communication device 130 may be a mobile device, a laptop computer, a tablet computer, a smartphone, a GPS or any other portable device with radio capability. While the embodiment of FIG. 1 shows device 130 as a smartphone, the disclosure is not limited thereto and device 130 may define any device seeking its position within an environment.

During an exemplary implementation, device 130 scans environment 100 to identify APs 120, 122 and 124. A software program or an applet (App) may be used for this function. Scanning may occur continuously or after a triggering event. The triggering event can be receipt of a new beacon signal, turning on device 130 or upon opening or updating a particular App. Alternatively, scanning can occur during regular intervals (e.g., every minute).

Once scanned, device 130 may identify each of APs 120, 122 and 124. Device 130 may measure the signal strength for each AP and identify the AP with the strongest RSSI. Positioning device 130 immediately under AP 120 provides identical x and y Cartesian coordinates for AP 120 and device 130. Consequently, multipath signal propagation may be minimized. It should be noted that while device 130 is shown immediately below AP 120, the disclosed embodiments are not limited thereto and can be applied when AP 120 and device 130 are positioned proximate to each other so as to reduce signal multipath.

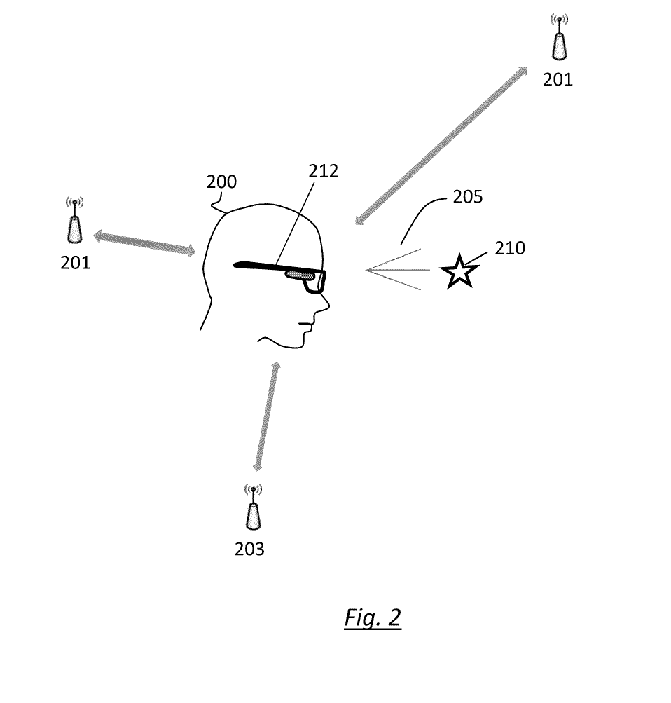

FIG. 2 is an exemplary representation of an embodiment of the disclosure. In the embodiment of FIG. 2, observer 200 is equipped with a head-mount based smart glasses 212 capable of determining depth or distance to object 210. Object 210 is in the field-of-view (FOV) 205 of observer 200. Smart glasses 212 are also in wireless communication with each of AP 201, AP 202 and AP 203. In one exemplary embodiment, smart glasses 212 determine a range to each of AP 201, AP 202 and AP 203. The range determination may be made using ToF or the so-called Fine Timing Measurement (FTM) calculation based on the relevant signal transmission. The FTM, as proposed in IEEE 802.11mc (Draft 1.0), may be used by non-AP mobile stations (STA) in a way to determine its differential distance with the two STAs that are involved in the FTM exchange. This provides a scalable solution for location determination.

In one embodiment of the disclosure, smart glasses 212 are used to determine the depth or distance to object 210 while simultaneously determining ToF measurements from each of AP 201, 202 and 203. Using a combination of depth measurement from smart glasses 212 and ToF measurements, smart glasses 212 may determine its exact location in relationship to the APs 201, 202, 203 and object 210.

In one implementation, object 210 includes distinct features to enable its immediate identification. In another embodiment, object 210 defines an anchor object such as a building, a sign, a monument or other landmarks with immediately recognizable features. For example, object 210 may comprises features that make the object immediately recognized among a database of similarly recognizable objects. One or more optical distance sensors (or proximity sensors) may be used in combination with an optical lens train to determine distance from the object. Conventional proximity sensors emit electromagnetic radiation (e.g., infrared) and look for changes in the field or the return signal from the target to measure distance to target.

Exemplary location algorithms that use ToF measurement from APs 201, 202 and 203 along with optical measurements may include trilateration and Kalman filtering. Trilateration is a known process for determining absolute or relative locations of points by measuring distances using geometry of circles, spheres or triangles. Trilateration is often used in location determination with global positioning systems (GPS). In contrast to triangulation, trilateration does not involve the measurement of angels. In three-dimensional geometry, when it is known that a point lies on the surfaces of three spheres, then the centers of the three spheres along with their radii provide sufficient information to narrow the possible locations. Additional information may be used to narrow the location possibilities down to one unique location.

Kalman filtering is also known as the linear quadratic estimation. Kalman filtering is an algorithm that uses a series of measurements observed over time and produces estimates of unknown variables that tend to be more precise than those based on a single measurement alone. Each measurements may contain noise and other random variations. The Kalman filter operates recursively on streams of noisy input data to produce a statistically optimal estimate for the underlying determination. The Kalman algorithm works in a two-step process. In the first step, the Kalman filter produces estimates of the current state variables, along with their uncertainties. Once the outcome of the next measurement (which includes additional random noise) is observed, these estimates are updated using a weighted average. More weight is given to estimates with higher certainty. Because the algorithm is recursive, it can be run in real time using the present input measurements, the previously calculated state and its uncertainty matrix.

In disclosed embodiments, the different characteristics of ToF range measurements and camera depth measurements complement each other and provide excellent overall position estimation data. Such characteristics include, for example, effective range measurement, measurement error and the like.

By actively tracking the device location based on the desired accuracy and power budget, a location engine according to one embodiment of the disclosure may choose to opt out from measuring the entire set of possible range-sources. The location engine may selectively and dynamically choose between ToF measurements, optical camera measurements or other available location and/or ranging resources (e.g., BLE, GPS, etc.). The resulting measurements may be combined or fused together to provide a hybrid location detection system.

In certain embodiments, the location engine dynamically switches between various available location determination resources as a function of available or budged device power. For example, the location engine may use a combination of ToF with known APs and camera distance measurement from an anchor object to self-locate. The location engine may then cease all location determination operations until movement is determined from one or more inertial sensors associated with the mobile device. Once movement is detected, the location engine may rely on ToF measurements or other resources to determine a new location for the mobile device. In this manner, the camera power consumption is minimized to initial location determination.

Anchor identification may be implemented locally or with the aid of one or more external servers. For example, the smart device may immediately recognize a well-known anchor object (e.g., the Washington monument) and recognizes the coordinates for the anchor. In a another embodiment, the smart device identifies the anchor objects and requests the coordinates for the anchor object from a server in communication therewith. The server may be a cloud-based server.

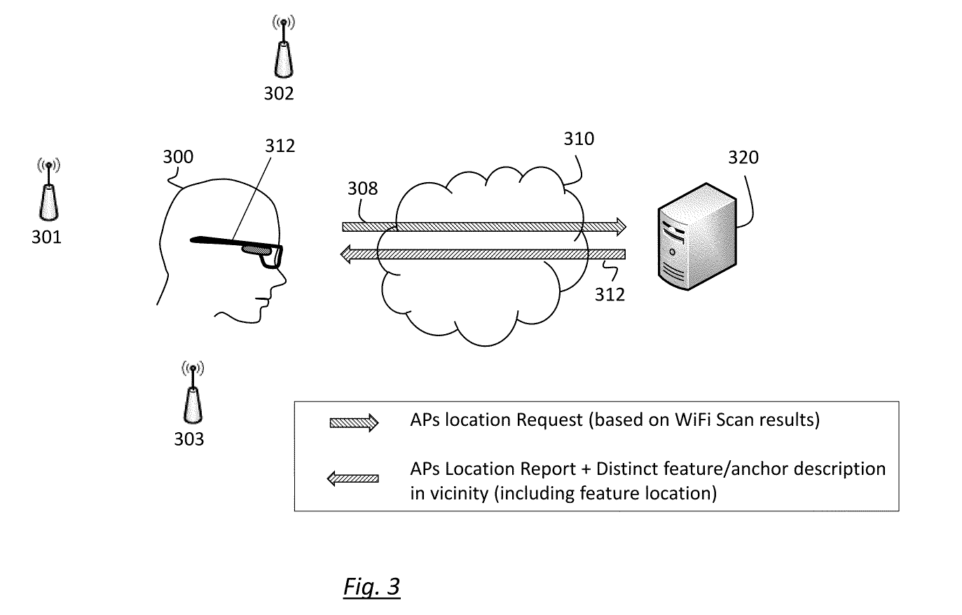

FIG. 3 schematically represents a location determination environment according to certain embodiments of the disclosure. Specifically, FIG. 3 shows a navigation device remote from both the observer and the smart device. In FIG. 3, observer 300 is equipped with smart glasses 312. The smart device 312 communicates with one or more of AP 301, AP 302 and AP 303. Once smart device 312 identifies an anchor object (not shown), the anchor object information may be transmitted 308 through cloud 310 to location network server 320.

In another embodiment of the disclosure, smart glasses 312 conduct a Wi-Fi scan to identify each of communicating APs 301, 302 and 303. Smart device 312 may then communicate 308 with server 320 and request location information for each of the identified APs. Location networks server 320 responds with location report for each of APs 301, 302 and 303. Location network server 320 may optionally provide distinct features or anchor descriptions in the vicinity of observer 300. Smart device 312 may use course information (based on known APs) to locate an anchor object for further location accuracy. In one embodiment, communication 312 from location network server 312 includes location information for observer 300. The received distinct features and/or anchors may be used by the device's depth camera to be identify the anchor object and measure a distance therefrom. If anchor information is unavailable, a course location information may be determined solely in relation to the location of the APs 301, 302 and 303.

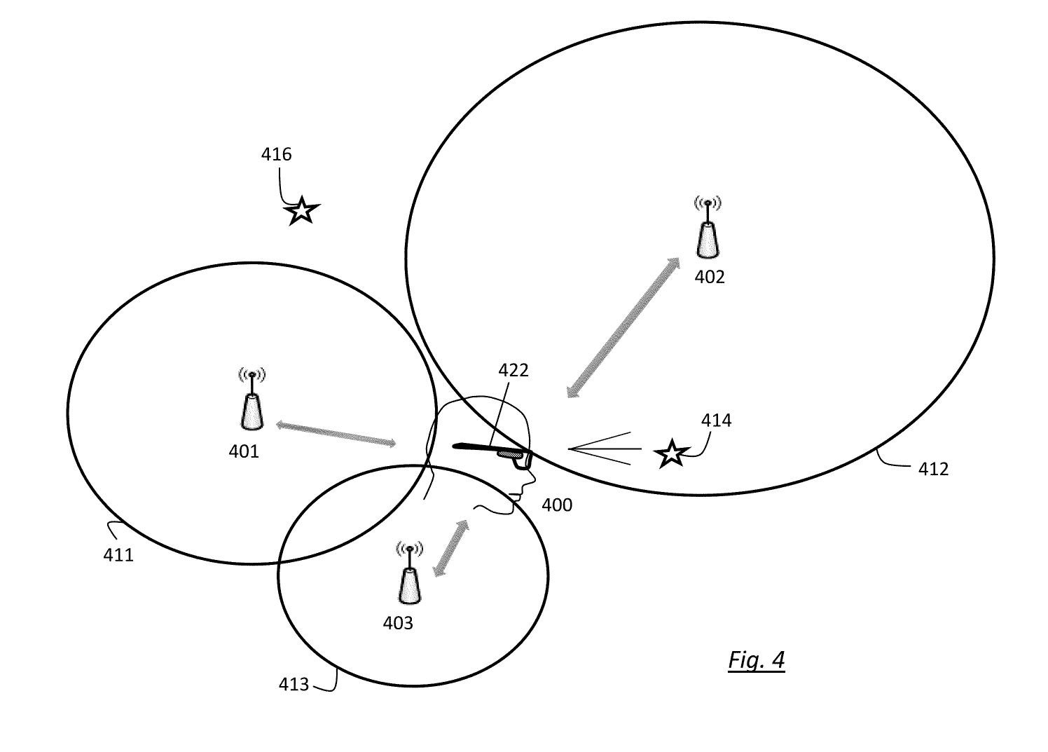

FIG. 4 schematically represents accurate location determination where conflicting anchors are present. Specifically, FIG. 4 illustrates an embodiment of the disclosure where boundary condition is used to eliminate inapplicable location solutions. In FIG. 4 observer 400 is equipped with smart device 422. Smart device 422 may include, for example, smart glasses, smart phone, head mount camera or any other device capable of optical distance determination. Each of APs 401, 402 and 403 provides signal coverage as schematically represented by coverage areas 411, 412 and 413, respectively. One or more of APs 401, 402 and 403 may be engaged in Wi-Fi communication with smart device 422. Smart device 422 and APs 401, 402 and 403 may also communicate with a location networks server (not shown) as discussed in relation to FIG. 3.

Anchor or object 414 may be within the FOV of smart device 422. Anchor or object 416 may also be in the vicinity or within the FOV of observer 400. As show in FIG. 4, anchor or object 416 may be located outside the range served by APs 401, 402 and 403. In certain embodiments of the disclosure, Wi-Fi ToF measurements may be used by a location engine to eliminate object 416 in the vicinity of the user as a potential solution in determining observer location. Even though anchor or object 416 is within the FOV of smart device 422, it will be eliminated in determining a potential location solution for observer 400 because it is outside of the signal coverage perimeter 411, 412 and 413. In other words, perimeters 411, 412 and 413 may be used to eliminate objects or anchors that reside outside these perimeters. Thus, in case multiple features are in the vicinity of user 400, Wi-Fi ToF may be used by location engine to pinpoint the observer's actual location and eliminate one or more possible locations that may erroneously bias location calculation.

In certain embodiments, the location engine is implemented at a chipset. The chipset may define a Wi-Fi chipset or it may be an optical depth camera chipset. In certain embodiments, the chipset defines an independent processor circuitry in communication with one or more of an optical camera and a Wi-Fi processor configured to determine ToF measurements to various APs. In another embodiment, the location engine may be a processor circuitry in communication with a camera and a Wi-Fi card. The processor circuitry may define smart device, an tablet or a computer.

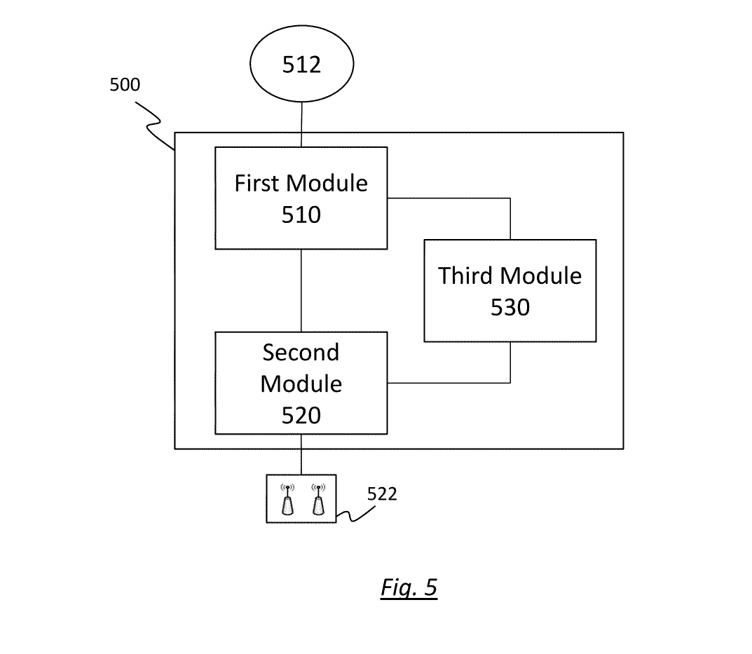

FIG. 5 is an exemplary apparatus for implementing an embodiment of the disclosure. Apparatus 500 of FIG. 5 may define a processor circuitry for implementing the disclosed embodiments. Apparatus 500 may be a chipset, a computer, a tablet or any other computing device configured to communicate with an optical camera and an access point. Apparatus 500 may be collocated or integrated with a mobile device (not shown). Apparatus 500 is shown with first module 510, second module 520 and third module 530. Each of the first, second or third module may further comprise one or more processor and memory circuitry configured to carry out the desired task. In another embodiment, each of modules 510, 520 and 530 defines a logical module implemented as hardware, software or a combination of hardware and software. It should be noted that while apparatus 500 is shown with three modules, the disclosed embodiments are not limited thereto and may include more or less operational module than shown in FIG. 5.

In the exemplary embodiment of FIG. 5, first module 510 may be configured to communicate with optical camera 512. Optical camera 512 may comprise any conventional camera capable of measuring an optical distance from an object within its FOV. The optical camera may be a 2D or 3D camera, including optical lens train (not shown), zooming capability (not shown) and optical to digital conversion circuitry (not shown). In one embodiment, optical camera 512 provides optical distance (i.e., depth) information to an object or to an anchor. The object may embedded location information (e.g., Quick Response (QR) Codes or other barcodes).

Second module 520 may be configured to communicate with one or more APs 522. Second module 522 may comprise communication hardware and software to wirelessly communicate with APs 522. In this manner, second module 520 may comprise Wi-Fi communication hardware and software. Alternatively, second module 522 may communicate with a transceiver component (not shown) which communicates wirelessly with APs 522. Second module 520 may estimate or determine a range between the mobile device and the APs 522. In one embodiment, a transceiver component (not shown) wirelessly communicates with APs 522 and measures the Round-Trip-Time (RTT) for signal propagation to each AP. The transceiver module may be integrated with second module 520. Second module 520 may then estimate a range between the mobile device and the one or more APs 522. In another embodiment, transceiver module 520 estimates the range to APs 522 and reports the estimate to second module 520. In still another embodiment, second module 520 identifies APs 522 to a location network server (not shown) and obtains location information for APs 522 and/or an estimated own location from the location network server (not shown). First module 510 and second 520 may optionally communicate with each other. Second module 520 may use conventional trilateration to determine a course location for the mobile device.

Third module 530 may communicates with each of first module 510 and second module 520. Third module 530 may include processor circuitry to receive optical distance information from first module 510 and AP range information from second module 520 and determine location of the mobile device based on the received information. Third module 530 may apply one of known positioning algorithms to determine location of the mobile device. For example, third module 530 may apply trilateration or Kalman filtering to locate the mobile device. In certain embodiments, the third module may be further configured to track location and movement of the mobile device.

In other embodiments, third module 530 may communicate with external sensors (not shown) to determine when the mobile device is moving. The external sensor may include GPS, Global Navigation Satellite System (GNSS) or inertial sensors associated with the mobile device. By communicating with these sensors, third module 530 can conserve power and activate apparatus 500 only when movement and relocation is detected.

In certain embodiments, apparatus 500 communicates with surrounding devices using other platforms including BT or BLE. Such communication can be made to locate the mobile device relative to other nearby devices. In one exemplary embodiment, BT or BLE beacons may be used as another sensor information by the location engine. Such information may be proximity measurement from such beacons and/or devices. The BT/BLE beacons may be used in addition to the Wi-Fi camera measurements

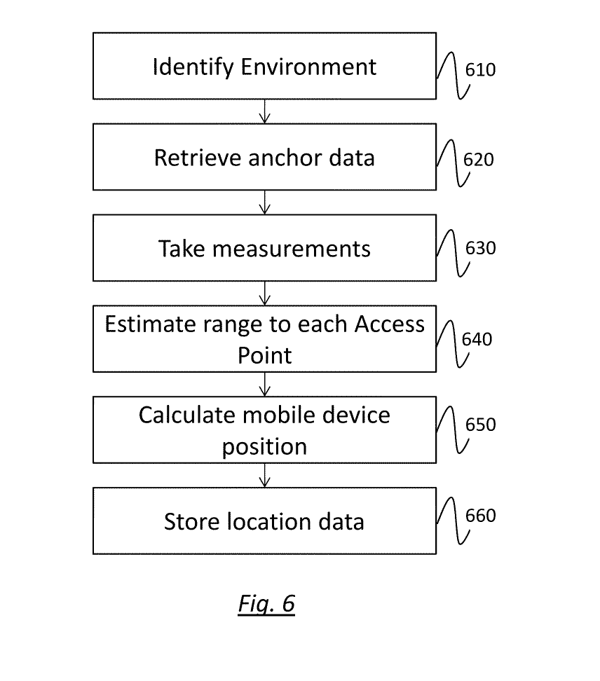

Certain embodiments of the disclosure may be implemented as computer readable instructions which may be uploaded on existing hardware or may be added as firmware to existing devices. In one embodiment, the computer readable instructions may be stored on a storage device capable of storing and/or executing the instructions. FIG. 6 shows exemplary steps implemented by one such storage device. In step 610, the mobile device identifies its immediate environment. Step 610 may include identifying local APs and, optionally, nearby BT/BLE devices. At step 620, one or more anchor objects within the FOV are identified. The anchor object may be a sign, a building or any other unique structure whose location may be immediately discerned. The location (coordinates) of the anchor object may be obtained from a local or an external database. There may be a plurality of anchor objects within the FOV. As discussed, additional range information may be used to eliminate out-of-range anchor objects.

At step 630 optical measurements are made to determine distance from each of the anchor objects identified at Step 620. The distance data may be stored at a memory module. At step 640 an range estimate is made to each of the identified APs (see step 610). Any of the conventional algorithm for estimating range may be used for this step. The result of step 640 is an estimated coarse location for the mobile device. At step 650, the course location (step 640) and optical distance measurement (step 630) are used to calculate location of the mobile device. Step 650 may optionally include elimination of out of range anchor points. The calculated location information of step 650 is stored at step 660 for further use.

The following are exemplary and non-limiting embodiments of the disclosure and are presented for illustrative purposes. Example 1 relates to a system-on-chip (SOC) to locate a mobile device, comprising: a first module to receive optical information form an optical system associated with the mobile device, the optical information including an optically-estimated distance between the mobile device and an anchor object; a second module to estimate a range between the mobile device and at least one access point (AP); and a third module to determine location of the mobile device as a function of the optically-estimated distance and the range.

Example 2 relates to the SOC of example 1, wherein the first module is configured to identify the anchor object using a Quick Response (QR) code or a barcode associated with the anchor object, retrieve known coordinates associated with the QR or barcode and estimate a coarse location as a function of the known coordinates.

Example 3 relates to the SOC of example 1, wherein the first module receives the optically-estimated distance from an optical distance sensor.

Example 4 relates to the SOC of example 1, wherein the second module is further configured to estimate the range between the mobile device and at least one AP by applying a Round-Trip-Time determination.

Example 5 relates to the SOC of example 1, wherein the third module is configured to track location and movement of the mobile device based on movement information received from an external sensor.

Example 6 relates to the SOC of example 1, wherein one of second or third module eliminates a secondary anchor object within the field of view when the secondary anchor object is outside of the estimated range between the mobile device and the at least one AP.

Example 7 relates to a tangible machine-readable non-transitory storage medium that contains instructions, which when executed by one or more processors result in performing operations comprising: optically measuring a distance between a mobile device and an anchor object to obtain an optical distance; identifying an access point (AP) within communication range of the mobile device and determining a range distance between the mobile device and the AP; calculating location of the mobile device as a function of the optical distance and the range distance between the mobile device and the AP.

Example 8 relates to the tangible machine-readable non-transitory storage medium of example 7, wherein the instructions further comprise identifying the anchor object with a Quick Response code or a barcode, retrieving coordinates for the anchor object and calculating a coarse location as a function of the optical distance and the anchor object coordinates.

Example 9 relates to the tangible machine-readable non-transitory storage medium of example 7, wherein determining optical distance further comprise receiving location of the anchor object and estimating a coarse location.

Example 10 relates to the tangible machine-readable non-transitory storage medium of example 7, wherein determining range distance further comprise receiving coordinates of the AP and estimating a coarse location in relation to the AP.

Example 11 relates to the tangible machine-readable non-transitory storage medium of example 7, wherein the instructions further comprise tracking and storing movement of the mobile device by receiving movement information from one or more sensors associated with the mobile device.

Example 12 relates to a self-locating apparatus comprising one or more processors and circuitry, the circuitry including: a first logic to optically estimate distance between the apparatus and an anchor object; a second logic to estimate a range between the apparatus and at least one access point (AP); and a third logic to determine location of the mobile device as a function of the optically-estimated distance and the range.

Example 13 relates to the self-locating apparatus of example 12, wherein the first module is configured to identify the anchor object using a Quick Response (QR) code or a barcode associated with the anchor object, retrieve known coordinates associated with the QR or barcode and estimate a coarse location as a function of the known coordinates.

Example 14 relates to the self-locating apparatus of example 12, wherein the first logic is further configured to retrieve location of the anchor object from a database and determine a coarse location in relation to the distance from the anchor object.

Example 15 relates to the self-locating apparatus of example 12, wherein the second logic is further configured to estimate the range between the apparatus and the anchor object by applying a Round-Trip-Time determination.

Example 16 relates to the self-locating apparatus of example 12, wherein the third logic is configured to track location and movement of the apparatus.

Example 17 relates to the self-locating apparatus of example 12, wherein one of second or third module eliminates a secondary anchor object within the field of view when the secondary anchor object is outside of the estimated range between the mobile device and the at least one AP.

Example 18 is directed to a method to locate of a mobile device, the method comprising: measuring, with an optical sensor, a distance between a mobile device and an anchor object to obtain an optical distance; identifying an access point (AP) within communication range of the mobile device and determining a range distance between the mobile device and the AP; calculating location of the mobile device as a function of the optical distance and the range distance between the mobile device and the AP.

Example 19 is directed to the method of example 18, further comprising identifying the anchor object using a Quick Response (QR) code or a barcode associated with the anchor object, retrieving known coordinates associated with the QR or barcode and estimating a coarse location as a function of the known coordinates.

Example 20 is directed to the method of example 18, further comprising retrieving location of the anchor object from a database and determining a coarse location in relation to the distance from the anchor object.

Example 21 is directed to the method of example 18, further comprising estimating the range between the apparatus and the anchor object by applying a Round-Trip-Time determination.

Example 22 is directed to the method of example 18, further comprising tracking location and movement of the mobile device.

Example 23 is directed to the method of example 18, further comprising eliminating a secondary anchor object within the field of view when the secondary anchor object is outside of the estimated range between the mobile device and the at least one AP.

While the principles of the disclosure have been illustrated in relation to the exemplary embodiments shown herein, the principles of the disclosure are not limited thereto and include any modification, variation or permutation thereof.

What is claimed is:

1. A system-on-chip (SOC) to locate a mobile device, comprising:
a first module to receive optical information form an optical system associated with the mobile device, the optical information including an optically-estimated distance between the mobile device and an anchor object;
a second module to estimate a range between the mobile device and at least one access point (AP); and
a third module to determine location of the mobile device as a function of the optically-estimated distance and the range.

2. The SOC of claim 1, wherein the first module is configured to identify the anchor object using a Quick Response (QR) code or a barcode associated with the anchor object, retrieve known coordinates associated with the QR or barcode and estimate a coarse location as a function of the known coordinates.

3. The SOC of claim 1, wherein the first module receives the optically-estimated distance from an optical distance sensor.

4. The SOC of claim 1, wherein the second module is further configured to estimate the range between the mobile device and at least one AP by applying a Round-Trip-Time determination.

5. The SOC of claim 1, wherein the third module is configured to track location and movement of the mobile device based on movement information received from an external sensor.

6. The SOC of claim 1, wherein one of second or third module eliminates a secondary anchor object within the field of view when the secondary anchor object is outside of the estimated range between the mobile device and the at least one AP.

7. A tangible machine-readable non-transitory storage medium that contains instructions, which when executed by one or more processors result in performing operations comprising:
optically measuring a distance between a mobile device and an anchor object to obtain an optical distance;
identifying an access point (AP) within communication range of the mobile device and determining a range distance between the mobile device and the AP;
calculating location of the mobile device as a function of the optical distance and the range distance between the mobile device and the AP.

8. The tangible machine-readable non-transitory storage medium of claim 7, wherein the instructions further comprise identifying the anchor object with a Quick Response code or a barcode, retrieving coordinates for the anchor object and calculating a coarse location as a function of the optical distance and the anchor object coordinates.

9. The tangible machine-readable non-transitory storage medium of claim 7, wherein determining optical distance further comprise receiving location of the anchor object and estimating a coarse location.

10. The tangible machine-readable non-transitory storage medium of claim 7, wherein determining range distance further comprise receiving coordinates of the AP and estimating a coarse location in relation to the AP.

11. The tangible machine-readable non-transitory storage medium of claim 7, wherein the instructions further comprise tracking and storing movement of the mobile device by receiving movement information from one or more sensors associated with the mobile device.

12. A self-locating apparatus comprising one or more processors and circuitry, the circuitry including:
a first logic to optically estimate distance between the apparatus and an anchor object;
a second logic to estimate a range between the apparatus and at least one access point (AP); and
a third logic to determine location of the mobile device as a function of the optically-estimated distance and the range.

13. The self-locating apparatus of claim 12, wherein the first module is configured to identify the anchor object using a Quick Response (QR) code or a barcode associated with the anchor object, retrieve known coordinates associated with the QR or barcode and estimate a coarse location as a function of the known coordinates.

14. The self-locating apparatus of claim 12, wherein the first logic is further configured to retrieve location of the anchor object from a database and determine a coarse location in relation to the distance from the anchor object.

15. The self-locating apparatus of claim 12, wherein the second logic is further configured to estimate the range between the apparatus and the anchor object by applying a Round-Trip-Time determination.

16. The self-locating apparatus of claim 12, wherein the third logic is configured to track location and movement of the apparatus.

17. The self-locating apparatus of claim 12, wherein one of second or third module eliminates a secondary anchor object within the field of view when the secondary anchor object is outside of the estimated range between the mobile device and the at least one AP.

18. A method to locate of a mobile device, the method comprising:
measuring, with an optical sensor, a distance between a mobile device and an anchor object to obtain an optical distance;
identifying an access point (AP) within communication range of the mobile device and determining a range distance between the mobile device and the AP;
calculating location of the mobile device as a function of the optical distance and the range distance between the mobile device and the AP.

19. The method of claim 18, further comprising identifying the anchor object using a Quick Response (QR) code or a barcode associated with the anchor object, retrieving known coordinates associated with the QR or barcode and estimating a coarse location as a function of the known coordinates.

20. The method of claim 18, further comprising retrieving location of the anchor object from a database and determining a coarse location in relation to the distance from the anchor object.

21. The method of claim 18, further comprising estimating the range between the apparatus and the anchor object by applying a Round-Trip-Time determination.

22. The method of claim 18, further comprising tracking location and movement of the mobile device.

23. The method of claim 18, further comprising eliminating a secondary anchor object within the field of view when the secondary anchor object is outside of the estimated range between the mobile device and the at least one AP.
